(19) United States
(12) Patent Application Publication
(10) Pub. No.: US 2009/0294468 A1
(43) Pub. Date: Dec. 3, 2009

(54) Method and Apparatus for Dispensing

(76) Inventor: Raymond Tom, Emerald Hills, CA (US)

Correspondence Address: DAVIS & ASSOCIATES, P.O. BOX 1093, DRIPPING SPRINGS, TX, 78620, US

(21) Appl. No.: 12/127,822

(22) Filed: May 28, 2008

(51) Int. Cl. B67D 5/60; B65D 88/54

(52) U.S. Cl. 222/1; 222/321.5; 222/464.1; 222/464.7

(57) ABSTRACT

An apparatus for dispensing product includes a container with a collection region. The collection region is characterized in part by a selected cross-section having an area smaller than a cross-section of the container preceding the selected cross-section while traveling in a direction of a gravity vector. The cross-sectional areas are proscribed by boundaries of the container on planes normal to the gravity vector. One end of a draw tube is disposed within the collection region. A pump draws product from the collection region through the draw tube. The pump dispenses the product external to the container.

### TECHNICAL FIELD

This invention relates to the fields of packaging and dispensing. In particular, this invention is drawn to methods and apparatus for dispensing products.

### BACKGROUND

Consumable goods such as condiments, liquid soaps, colognes, perfumes, and lotions are often distributed in containers with a manual pump, a gravity feed spigot. In some cases, they may be distributed in squeezable containers. The contents of the container are dispensed by operating the manual pump, opening the spigot, or squeezing the container.

One form of waste that can occur is product drip. After dispensing, the product may continue to leak or drip from the dispenser. One approach to reducing this form of waste is to design the pumps, spigots, or container openings to inhibit the delivery of the product except when the container is squeezed or when the pump or spigot is operated. Such dispensers are designed to ameliorate waste attributable to dripping.

Changes in the design of the pumps, spigots, or container openings do not address waste resulting from the inability of the pump to extract all of the product from the container. Usable product often remains inaccessible in the container despite the attempts to pump or squeeze the product out of the container.

### SUMMARY

One embodiment of an apparatus for dispensing product includes a container with a collection region. The collection region is characterized in part by a selected cross-section having an area smaller than a cross-section of the container preceding the selected cross-section while traveling in a direction of a gravity vector. The cross-sectional areas are proscribed by boundaries of the container on planes normal to the gravity vector. One end of a draw tube is disposed within the collection region. A pump draws product from the collection region through the draw tube. The pump dispenses the product external to the container.

One embodiment of a method of dispensing product includes providing a container with a collection region. The collection region is characterized in part by a selected cross-section having an area smaller than a cross-section of the container preceding the selected cross-section while traveling in a direction of a gravity vector. The cross-sectional areas are proscribed by boundaries of the container on planes normal to the gravity vector. A draw tube of a pump is disposed within the collection region. The pump is operated to draw product from the collection region and dispense the product external to the container.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates one embodiment of a dispensing apparatus.

FIG. 2 illustrates an expanded view of a container.

FIG. 3 illustrates one embodiment of features for coupling a container to a stand.

FIG. 4 illustrates one embodiment of a container.

FIG. 5 illustrates cross-sectional views of various embodiments of a container collection region.

FIG. 6 illustrates one embodiment of a method of dispensing product from a container.

FIG. 7 illustrates cross-sectional views of one embodiment of a container with a collection region.

FIG. 8 illustrates cross-sectional views of another embodiment of a container with a collection region.

FIG. 9 illustrates cross-sectional views of another embodiment of a container with a collection region.

FIG. 10 illustrates cross-sectional area profiles of various containers.

FIG. 11 illustrates another embodiment of a method of dispensing product from a container.

### DETAILED DESCRIPTION

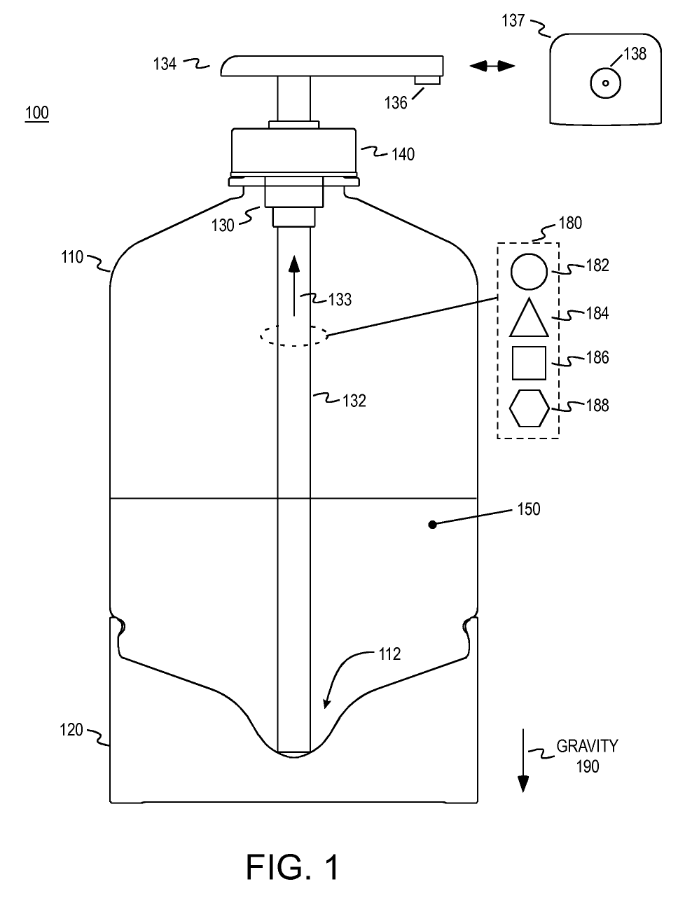

FIG. 1 illustrates one embodiment of a dispensing apparatus 100. The dispensing apparatus includes a container 110 and a pump 130. When the pump handle 134 is operated, product 150 is drawn from within the container through the pump 130 via the draw tube 132. The product is delivered by the pump to nozzle or outlet 136 where the product is dispensed. In the illustrated embodiment, the outlet is integrated into and moves with the handle.

A cap 140 aids in sealing the container after product has been placed in the container. In the illustrated embodiment, the cap also supports the pump, draw tube, and handle. If removable, the cap facilitates refilling the container with more product.

The draw tube is cylindrical in one embodiment such that a cross-section of the tube in a plane normal to the product flow 133 has a circular shape 182. The cross-section of the draw tube may have different shapes 180. Various embodiments of the draw tube may have polygonal-shaped cross-sections such as triangular 184, quadrilateral 186 (e.g., including square), or hexagonal 188 cross-sections.

Liquids, creams, gels, lotions, and ointments have varying characteristics. Alternate handles and outlets may be utilized depending upon the characteristics of the product 150 being dispensed and the desired form of application of the product.

The pump handle 134 and outlet 136 may be appropriate for liquid soaps and moisturizing lotions, however, some products may require dispensing in aerosol form. Liquid colognes and perfumes, for example, may be more appropriately dispensed in aerosol form. Accordingly, an alternative pump handle 137 and outlet 138 can be utilized for aerosol delivery.

The container includes a collection region 112. As the volume of product in the container is reduced, the remainder is drawn into the collection region due to gravity 190. In a plane orthogonal to the gravity vector 190, the collection region of the illustrated embodiment is characterized by decreasing cross-sectional area proscribed by the boundaries of the container on the plane as the plane is advanced in the direction of the gravity vector. One end of the draw tube is disposed within this collection region 112. The draw tube effectively extends the pump inlet to facilitate extracting product from the collection region.

Depending upon the manufacturing process used to form the container, the collection region may tend to extend from the body of the container such that the container cannot readily stand on a flat surface. In one embodiment the dispensing apparatus includes a stand 120. The stand 120 is coupled to the container 110 to enable the dispensing apparatus to stand on a flat surface.

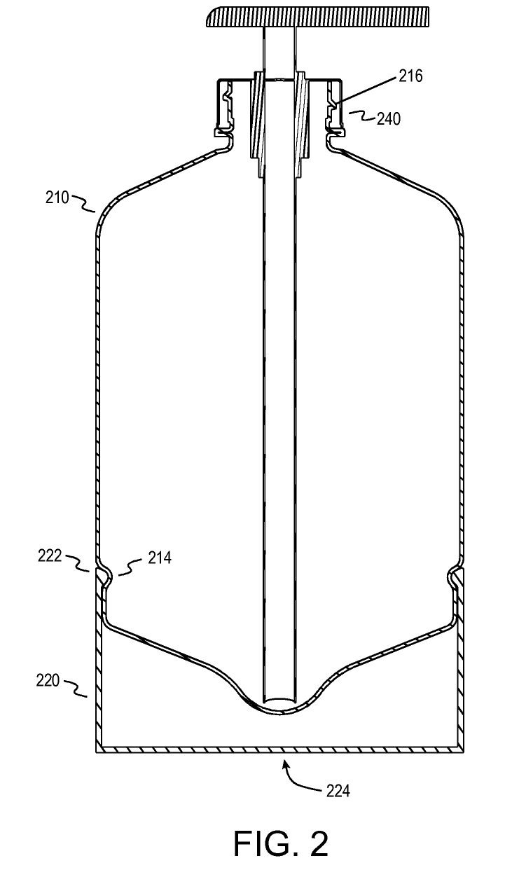

FIG. 2 illustrates a vertical cross-section of the dispensing apparatus. In one embodiment, the container includes threads 216. Cap 240 is threadably coupled to the container 210.

In one embodiment, the container includes features such as indentations 214 to facilitate mechanical coupling with stand 220. Stand 220 includes complementary coupling features 222. The stand includes a bottom 224 to enable the assembled dispensing apparatus to rest stably upon a flat surface such as a shelf or counter top. In the illustrated embodiment, the bottom 224 is flat.

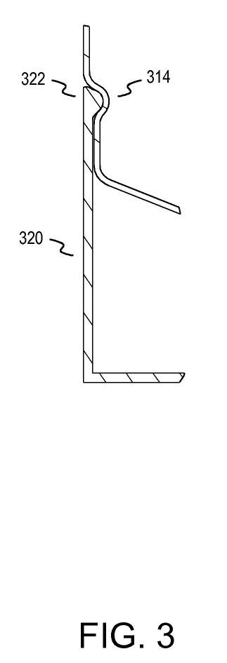

FIG. 3 illustrates a magnified view of one embodiment of the stand and container near the coupling region. In the illustrated embodiment, the stand and container include features to permit “snap-on” mechanical assembly. In some embodiments, the container includes indentations 314 and the stand 320 has complementary features 322 to facilitate coupling.

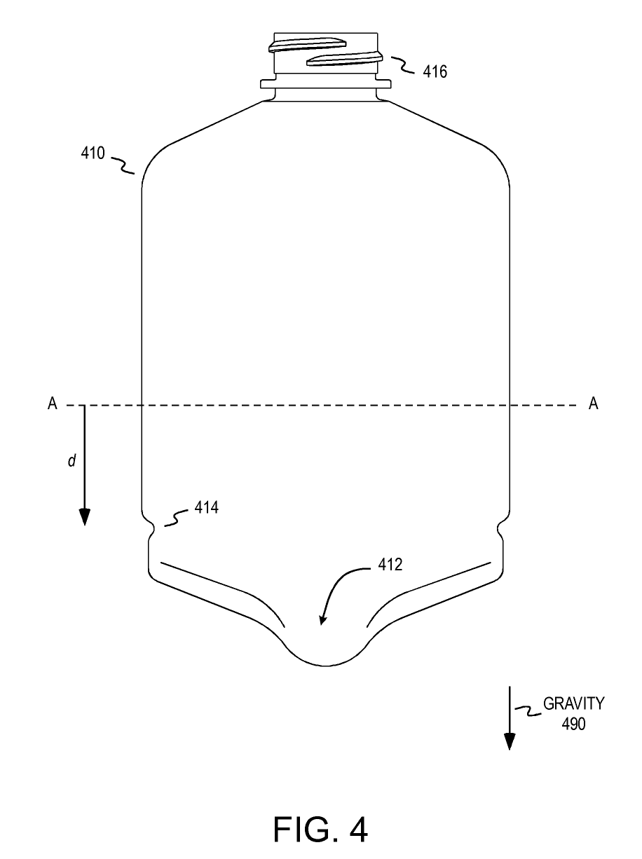

FIG. 4 illustrates one embodiment of the container 410. The container includes a collection region 412, coupling features 414 for a stand, and threads 416 for a cap.

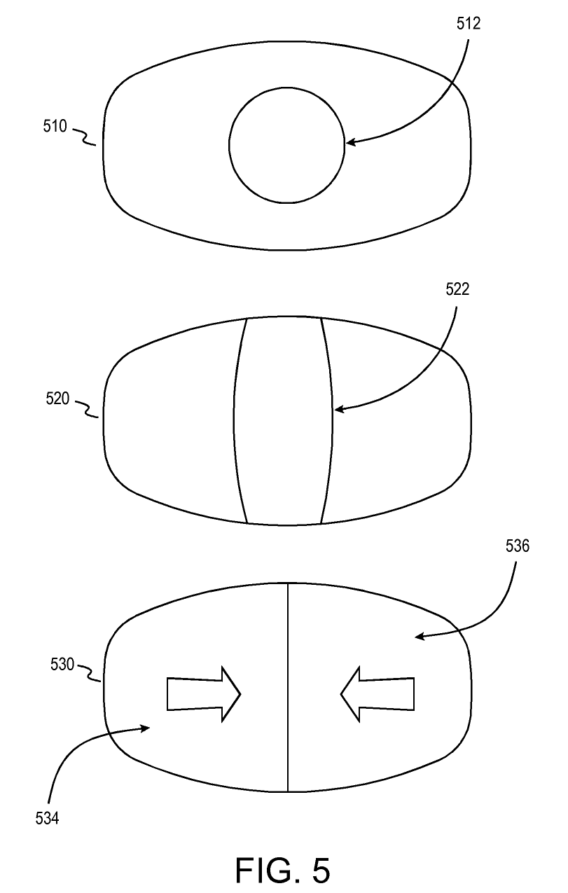

FIG. 5 illustrates various top views of a cross-section of the container of FIG. 4 along plane A. For example the collection region 512 may be generally circular in cross-section as illustrated in cross-section 510. The collection region 522 may be more elliptical or oval-shaped as illustrated in cross-section 520. In the embodiment 520, the cross-section of the collection region forms a truncated ellipse.

Cross-section 530 illustrates a cross-section for a container other than the container of FIG. 4. In this case the collection region 532 has sloping sides 534, 536.

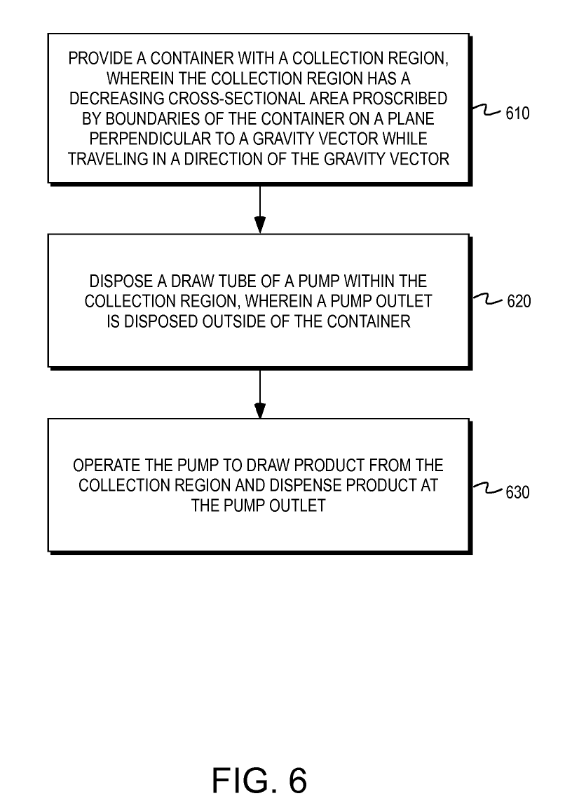

FIG. 6 illustrates one embodiment of a method of dispensing product from a container. A container with a collection region is provided at 610. The collection region has a decreasing cross-sectional area proscribed by boundaries of the container on a plane perpendicular (i.e., normal) to a gravity vector while traveling in a direction of the gravity vector. At 620, a draw tube of a pump is disposed within the collection region. The pump outlet is disposed outside of the container. At 630 the pump is operated to draw product from the collection region and dispense the product at the pump outlet.

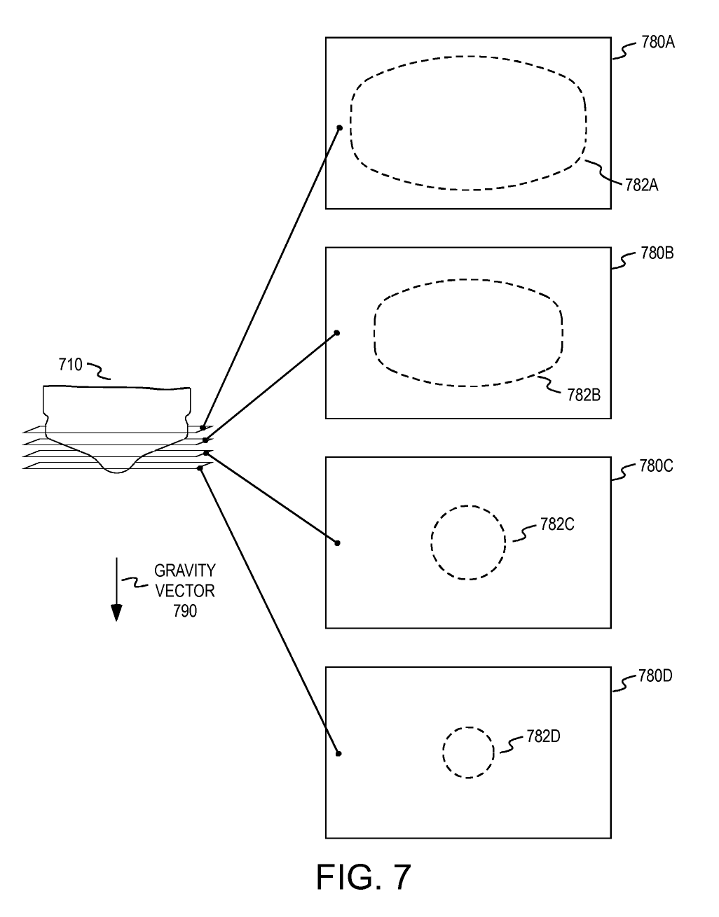

FIG. 7 illustrates cross-sectional views of one embodiment of a container 710 with a collection region. In this embodiment, the container including the collection region has a decreasing cross-sectional area 782A, 782B, 782C, 782D proscribed by boundaries of the container 710 on a plane 780A, 780B, 780C, 780D normal to a gravity vector 790 as the plane travels in a direction of the gravity vector.

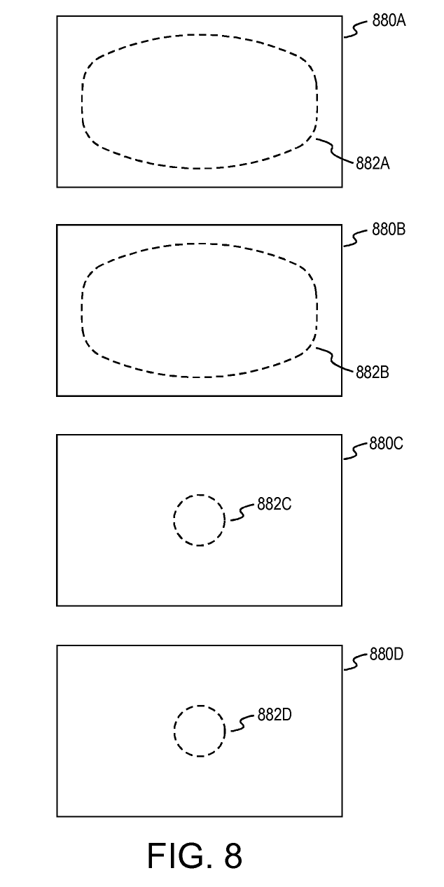

In some embodiments, the transition between the collection region and the remainder of the container is more abrupt. FIG. 8 illustrates cross-sectional views of another embodiment of a container with a collection region. In this embodiment, the container has substantially the same cross-sectional area 882A, 882B proscribed by boundaries of the container on a plane 880A, 880B normal to a gravity vector as the plane travels in a direction of the gravity vector. The collection region likewise has substantially the same cross-sectional area 882C, 882D proscribed by boundaries of the container on a plane 880C, 880D normal to a gravity vector as the plane travels in a direction of the gravity vector. The transition between the collection region and the remainder of the container is identified due to the abrupt change in area.

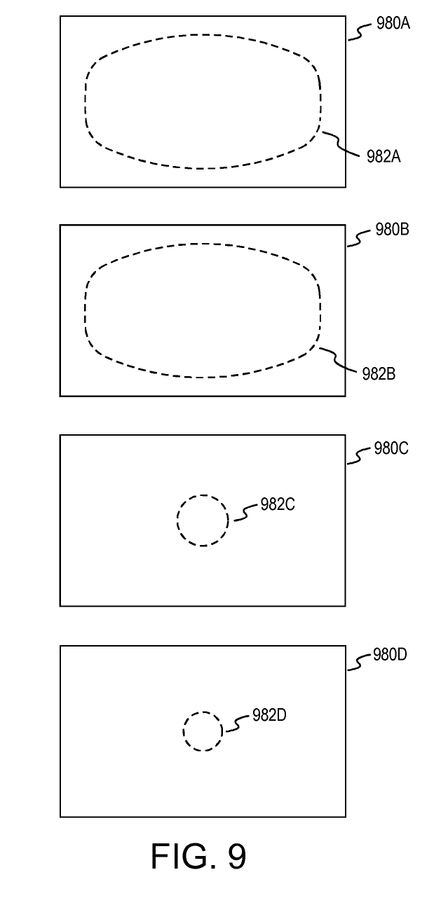

FIG. 9 illustrates cross-sectional views of another embodiment of a container with a collection region. The container has substantially the same cross-sectional area 982A, 982B proscribed by boundaries of the container on a plane 980A, 980B normal to a gravity vector as the plane travels in a direction of the gravity vector until encountering the collection region. The collection region has a decreasing cross-sectional area 982C, 982D proscribed by boundaries of the container on a plane 980C, 980D normal to a gravity vector as the plane travels in a direction of the gravity vector.

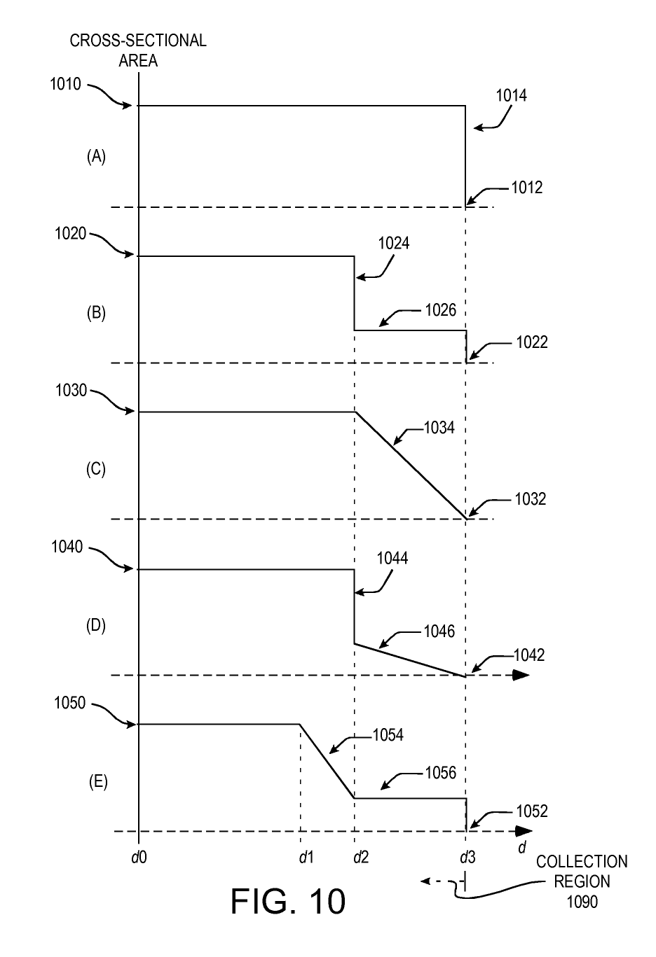

FIG. 10 illustrates cross-sectional profiles of various containers. In particular the y-axis corresponds to the area proscribed by the container on a plane normal to a gravity vector as the plane travels a distance d in a direction of the gravity vector. The x-axis corresponds to d (see also FIG. 4).

FIG. 10(a), for example, illustrates one embodiment of a cross-sectional area profile for a traditional container without a collection region. The area proscribed by the boundaries of the container on a plane normal to a gravity vector is substantially constant at 1010 while the plane travels from position d0 until reaching the bottom of the container at position d3 where the area is reduced to zero 1012. The transition 1014 is discontinuous and forms a step.

FIG. 10(b), illustrates one embodiment of a cross-sectional area profile for a container having an abrupt or stepped transition to a collection region. The area proscribed by the boundaries of the container on a plane normal to the gravity vector is substantially constant at 1020 from position d0 to d2. At position d2, the area transitions from 1020 to 1026. The transition 1024 from 1020 to 1026 is discontinuous. In the illustrated embodiment, the area stays constant at 1026 from position d2 to d3. The area then abruptly transitions to zero 1022.

The collection region of the container associated with FIG. 10(b) is clearly defined by the cross-sectional area profile. In particular, the collection region begins at position d2 and ends at d3. The cross-sectional area of the collection region is constant at 1026.

Other containers may have collection regions with less clearly defined beginning positions. FIG. 10(c), for example, has a cross-sectional area that is substantially constant at 1030 from position d0 to d2. However, the area transitions from 1030 at position d2 to zero 1032 at position d3. The transition 1034 from 1030 at d2 to 1032 at d3 is monotonically decreasing. In particular, the area ramps down from 1030 to 1032.

The collection region is inherently bound by the bottom of the container. In the illustrated embodiment, an upper bound for the beginning of the collection region might be defined by the transition occurring at d2. However, an additional constraint can be imposed to clearly distinguish the collection region from the remainder of the container. For example, the collection region may be defined to have a volume less than or equal to a pre-determined percentage of the volume of the container in order to establish at least a threshold volume to define boundaries of the collection region.

The collection region may be defined such that

$$\frac{{V}_{R}}{{V}_{T}} \cdot 100 \leq k \% ,$$

where V_{R} represents the volume of the collection region and V_{T} represents the volume of the container. In various embodiments, k is in a range of 0.5-10. Thus a collection region 1090 is bound by the bottom of the container at d3 and extends to a boundary defined by the characteristics of the cross-sectional area profile or a percentage of the total volume of the container or both.

The cross-sectional area profiles are not limited to ramps or steps. The profiles may be composed of combinations of ramps and steps or other characteristic curves.

FIG. 10(d), illustrates one embodiment of a cross-sectional area profile for a container having a step and ramp combination to form a collection region. The area proscribed by the boundaries of the container on a plane normal to the gravity vector has a step transition 1044 at d2 to a ramp 1046. The cross-sectional area ramps from a value less than level 1040 at position d2 to zero 1042 at position d3.

FIG. 10(e) illustrates another embodiment of a cross-sectional area profile for a container having a different step and ramp combination. The cross-sectional area is constant at level 1050 from d0 to d1. The area proscribed by the boundaries of the container on a plane normal to the gravity vector has a ramp transition 1054 starting at d1. The ramp terminates at a level 1056 above zero but less than level 1050 at d2. In the illustrated embodiment, the cross-sectional area stays constant at 1056 from position d2 to d3. The area then abruptly transitions to zero 1052.

The collection region is the first filled when introducing product into the container and the last emptied when removing product from the container. The cross-sectional area profile may vary greatly. Ramps and steps or other characteristic curves may be used to create the appropriately-sized collection region while meeting the desired overall volume constraints for the container. The cross-sectional area profile may also be tailored for the physical characteristics of the product to be dispensed. For example, a highly viscous product may require a collection region that begins with a greater cross-sectional area compared to the cross-sectional area of the beginning of a collection region utilized for a less viscous product. Soaps, shampoos, and pastes and lotions tend to be more viscous than perfumes or colognes, for example.

The draw tube intake is disposed within the collection region. The collection region significantly reduces the amount of product that is unobtainable with the draw tube compared to a container without such a collection region. The pump operates to draw product from the collection region for dispensing external to the container. The product is drawn out in a direction opposite the gravity vector.

Regardless of whether the collection region is defined in part by a ramped, stepped, or other cross-sectional area profile, the collection region includes a selected cross-sectional area that is decreased from at least one cross-sectional area of the container preceding the collection region while traveling in a direction of the gravity vector. Thus irrespective of whether the cross-sectional area of the collection region is fixed or varying, at some point a selected cross-section of the collection region has an area less than that of a cross-section of the container encountered prior to the selected cross-section when traveling in a direction of the gravity vector. The cross-sectional areas are proscribed by boundaries of the container on a plane normal to the gravity vector.

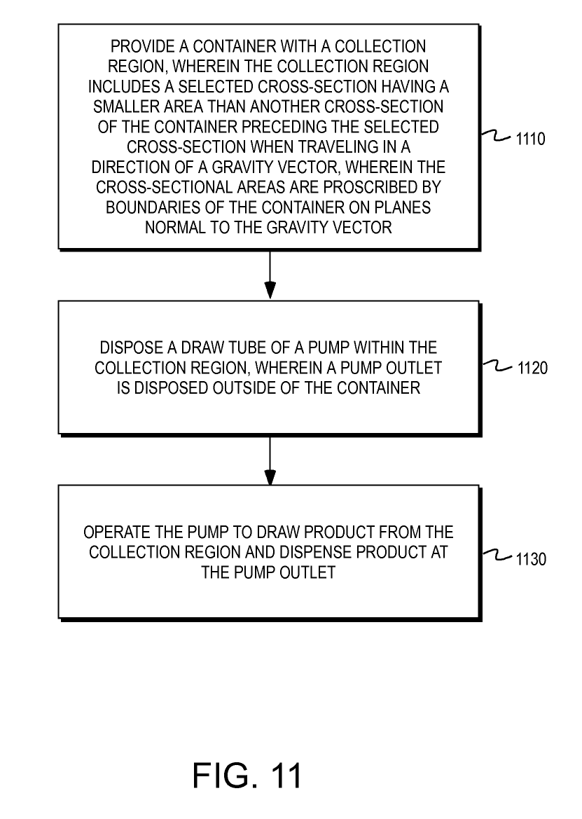

FIG. 11 illustrates an alternative embodiment of a method for dispensing product from a container. A container with a collection region is provided at 1110.

The collection region is characterized at least in part by a selected cross-section having an area smaller than a cross-section of the container preceding the selected cross-section while traveling in a direction of the gravity vector. The cross-sectional areas are proscribed by boundaries of the container on planes normal to the gravity vector.

At 1120, a draw tube of a pump is disposed within the collection region. At 1130, the pump is operated to draw product from the collection region and dispense the product external to the container.

In various embodiments, the collection region is further characterized as having a volume (V_{R}) less than some fraction of the total container volume (V_{T}). For example, in various embodiments,

$$\frac{{V}_{R}}{{V}_{T}} \leq k ,$$

wherein k is in a range of 0.5-10% (i.e., 0.005-0.10).

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A method of dispensing product comprises:
a) providing a container with a collection region, wherein the collection region is characterized in part by a selected cross-section having an area smaller than a cross-section of the container preceding the selected cross-section while traveling in a direction of a gravity vector, wherein the cross-sectional areas are proscribed by boundaries of the container on planes normal to the gravity vector;
b) disposing a draw tube of a pump within the collection region; and
c) operating the pump to draw product from the collection region and dispense the product external to the container.

2. The method of claim 1 wherein the draw tube is cylindrical.

3. The method of claim 1 wherein the draw tube has a polygonal cross-section proscribed by a plane normal to a path of the product through the draw tube.

4. The method of claim 3 wherein the cross-section of the draw tube has one of a triangle and a quadrilateral shape.

5. The method of claim 1 wherein the product is dispensed in aerosol form.

6. The method of claim 1 wherein the collection region has a substantially constant cross-section.

7. The method of claim 1 wherein the collection region has a monotonically decreasing cross-sectional area when traveling in a direction of the gravity vector.

8. The method of claim 1 wherein
$$\frac{{V}_{R}}{V} \leq k ,$$
wherein V_{R} is a volume of the collection region, wherein V is a volume of the container, wherein k is in a range of 0.005 to 0.10.

9. An apparatus for dispensing product comprising:
a container including a collection region, wherein the collection region is characterized in part by a selected cross-section having an area smaller than a cross-section of the container preceding the selected cross-section while traveling in a direction of a gravity vector, wherein the cross-sectional areas are proscribed by boundaries of the container on planes normal to the gravity vector;
a draw tube having one end disposed within the collection region; and
a pump operable to draw product from the collection region through the draw tube, wherein the pump dispenses the product external to the container.

10. The apparatus of claim 9 wherein the draw tube is cylindrical.

11. The apparatus of claim 9 wherein the draw tube has a polygonal cross-section proscribed by a plane normal to a path of the product through the draw tube.

12. The apparatus of claim 11 wherein the cross-section of the draw tube has one of a triangle and a quadrilateral shape.

13. The apparatus of claim 9 wherein the product is dispensed in aerosol form.

14. The apparatus of claim 9 wherein the collection region has a substantially constant cross-section.

15. The apparatus of claim 9 wherein the collection region has a monotonically decreasing cross-sectional area when traveling in a direction of the gravity vector.

16. The apparatus of claim 9 wherein
$$\frac{{V}_{R}}{V} \leq k ,$$
wherein V_{R} is a volume of the collection region, wherein V is a volume of the container, wherein k is in a range of 0.005 to 0.10.

17. The apparatus of claim 9 wherein the pump further comprises:
a handle for operating the pump, wherein the handle is disposed outside of the container, wherein the product is dispensed from an outlet integrated into the handle.

18. The apparatus of claim 9 further comprising:
a stand coupled to the container, wherein the stand enables the dispensing apparatus to stand on a flat surface.
